(19) United States
(12) Patent Application Publication
(10) Pub. No.: US 2023/0308953 A1
(43) Pub. Date: Sep. 28, 2023

(54) NETWORK PACKET HANDLING IN TRANSPORT DOMAIN

(71) Applicant: Cisco Technology, Inc., San Jose, CA (US)

(72) Inventors: Sunil Pareek, Karnataka (IN); Prathibha Devi Kathiresan, Bangalore (IN); Namita Bist, Delhi (IN)

(21) Appl. No.: 17/702,098

(22) Filed: Mar. 23, 2022

(51) Int. Cl. H04W 28/24; H04W 28/10; H04W 28/02

(52) U.S. Cl. CPC H04W 28/24; H04W 28/10; H04W 28/0268

(57) ABSTRACT

Techniques are provided for handling network packets in a transport domain. In one example, one or more parameters associated with a wireless device are obtained. Based on the one or more parameters, an indicator is identified that indicates how to handle network packets associated with the wireless device in a transport domain between a radio access network and a core network. A network packet associated with the wireless device is obtained, the indicator is inserted in the network packet, and the network packet is provided to the transport domain. The transport domain is configured to handle the network packet in the transport domain based on the indicator.

### TECHNICAL FIELD

The present disclosure relates to computer networking.

### BACKGROUND

Network slicing is a capability, offered by 5G networks, for treating network packets (e.g., data packets) of a User Equipment (UE) in a desired way. A network slice can be instantiated in one or more specific domains to provide communication for a riding application. Network slices may be classified by latency, bandwidth reservation, jitter, Service Level Agreement (SLA), priority, and other factors.

### BRIEF DESCRIPTION OF THE DRAWINGS

FIG. 1 illustrates a system configured to enable network packet handling in a transport domain, according to an example embodiment.

FIG. 2 illustrates a flowchart of a method for handling network packets in a transport domain, according to an example embodiment.

FIG. 3 illustrates a General Packet Radio Service (GPRS) Tunneling Protocol User Plane (GTP-U) extension header configured to store an indicator that indicates how to handle network packets in a transport domain, according to an example embodiment.

FIG. 4 illustrates a table that maps parameters associated with a wireless device with behavior identifiers that correspond to target behaviors of network packets in a transport domain, indicators that indicate how to handle network packets in a transport domain, and corresponding use cases, according to an example embodiment.

FIG. 5 illustrates a hardware block diagram of a computing device configured to perform functions associated with operations discussed herein, according to an example embodiment.

FIG. 6 illustrates a flowchart of a method for performing functions associated with operations discussed herein, according to an example embodiment.

### DESCRIPTION OF EXAMPLE EMBODIMENTS

### Overview

Techniques are provided for handling network packets in a transport domain. In one example embodiment, one or more parameters associated with a wireless device are obtained. Based on the one or more parameters, an indicator is identified that indicates how to handle network packets associated with the wireless device in a transport domain between a radio access network and a core network. A network packet associated with the wireless device is obtained, the indicator is inserted in the network packet, and the network packet is provided to the transport domain. The transport domain is configured to handle the network packet in the transport domain based on the indicator.

### EXAMPLE EMBODIMENTS

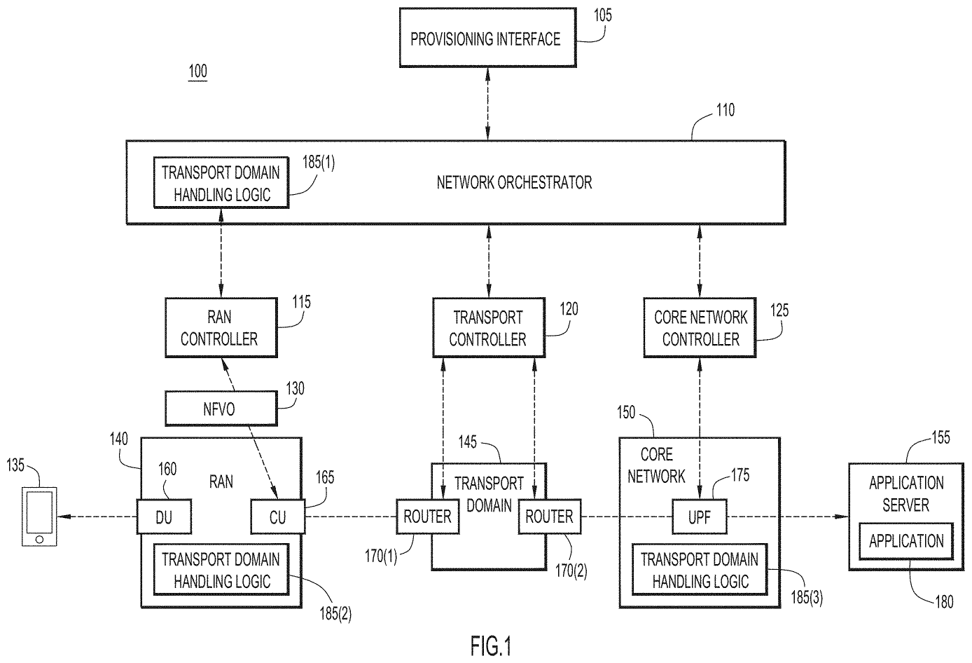

FIG. 1 illustrates a system 100 configured to enable transport domain handling of network packets, according to an example embodiment. System 100 includes provisioning interface 105, network orchestrator 110, Radio Access Network (RAN) controller 115, transport controller 120, core network controller 125, and Network Function Virtualization Orchestrator (NFVO) 130. System 100 further includes wireless device 135, RAN 140, transport domain 145, core network (also known as mobile core network) 150, and application server 155. RAN 140 includes Distributed Unit (DU) 160 and Centralized/Central Unit (CU) 165; transport domain 145 includes router 170(1) and router 170(2); core network 150 includes User Plane Function (UPF) 175; and application server 155 includes application 180.

Provisioning interface 105 may be a slice provisioning interface, such as a Communication Service Management Function (CSMF). Network orchestrator 110 may be an end-to-end network slice orchestrator, such as a Network Slice Management Function (NSMF). Network orchestrator 110 may also be referred to as a “master controller.” RAN controller 115, transport controller 120, and core network controller 125 may be slice controllers, such as Network Slice Subnet Management Functions (NSSMFs), configured to manage RAN 140, transport domain 145, and core network 150, respectively.

NFVO 130 may be responsible for managing virtualized functions, such as DU 160 and CU 165, in RAN 140. NFVO 130 may manage these virtualized functions based on any suitable orchestration mechanism (e.g., Kubernetes®, OpenStack®, etc.).

Wireless device 135 may be associated with any suitable device configured to initiate a flow in system 100. For example, wireless device 135 may include one or more computers, vehicles and/or any other transportation-related devices having electronic devices configured thereon, automation devices, enterprise devices, appliances, Internet of Things (IoT) devices, Personal Digital Assistant (PDAs), laptops or electronic notebooks, cellular telephones, smartphones, tablets, Internet Protocol (IP) phones, and/or any other devices and/or combination of devices, components, elements, and/or objects capable of initiating voice, audio, video, media, or data exchanges within system 100. Wireless device 135 may also include any suitable interface to a human user such as a microphone, a display, a keyboard, or other terminal equipment. Wireless device 135 may also be any devices that seek to initiate a communication on behalf of another entity or element such as a program, a database, or any other component, device, element, or object capable of initiating an exchange within system 100. Wireless device 135 may be configured with appropriate hardware (e.g., processor(s), memory element(s), antennas and/or antenna arrays, baseband processors (modems), and/or the like), software, logic, and/or the like to facilitate respective over-the-air (air) interfaces for accessing/connecting to RAN 140. In one example, wireless device 135 may be a User Equipment (UE).

RAN 140 may connect wireless device 135 and transport domain 145. DU 160 and CU 165 may be disaggregated components of a next generation NodeB (gNodeB). DU 160 may handle at least part of one or more lower layers of the protocol stack, and may be located topologically close to wireless device 135. CU 165 may handle at least part of one or more upper layers of the protocol stack, and may be located topologically far from wireless device 135. In one example, DU 160 is responsible for dealing with Layers 1 and 2, and CU 165 is responsible for dealing with higher layers (e.g., the General Packet Radio Service (GPRS) Tunneling Protocol User Plane (GTP-U) layer).

Transport domain 145 may connect RAN 140 and core network 150. Router 170(1) and router 170(2) may be edge routers of transport domain 145. In particular, router 170(1) may be configured to communicate with RAN 140, and router 170(2) may be configured to communicate with core network 150. For uplink packets (e.g., network packets propagating from wireless device 135 toward application server 155), router 170(1) may act as an ingress router and router 170(2) may act as an egress router. For downlink packets (e.g., network packets propagating from application server 155 toward wireless device 135), router 170(2) may act as an ingress router and router 170(1) may act as an egress router.

Core network 150 may connect transport domain 145 and application server 155. UPF 175 may be configured to route network packets between transport domain 145 and application server 155. In one example, core network 150 may be a 5G core network. Core network 150 may include any suitable core network elements in addition to UPF 175, such as a Session Management Function (SMF), an Access and Mobility Management Function (AMF), etc.

Application server 155 may provide one or more application-based services to wireless device 135. For example, application server 155 may host application 180, which may be configured to provide the services to wireless device 135. More specifically, application server 155 may obtain one or more uplink packets from wireless device 135 and, based on application 180, provide one or more downlink packets to wireless device 135. In one example, application server 155 may be a web server accessible over the Internet.

Conventionally, transport domain 145 would be incapable of appropriately handling network packets for a given use case. For example, conventionally, transport domain 145 might fail to provide sufficient bandwidth or latency for high-priority network packets. As a result, conventionally, transport domain 145 would not consistently handle network packets in accordance with the corresponding use case.

Therefore, in order to enable transport domain 145 to handle network traffic in a target/desired manner (e.g., in accordance with a given use case), transport domain handling logic 185(1)-185(3) is provided on network orchestrator 110, RAN 140, and core network 150, respectively. It will be appreciated that transport domain handling logic 185(1)-185(3) may be provided on any suitable network entity in system 100 in accordance with embodiments described herein.

The techniques described herein may extend network slicing based behavior in RAN 140 and/or core network 150 to transport domain 145. As a result, these techniques may effectively enable end-to-end network slicing capabilities over RAN 140, transport domain 145, and core network 150. Thus, in one example, network slice awareness may be provided to transport domain 145. As described herein, a dedicated or shared network slice may be dynamically provisioned for a session of wireless device 135 over transport domain 145.

The desired packet treatment may be ensured in transport domain 145 based on Quality of Service (QoS) (e.g., 5G QoS Identifier (5QI)), network slice, and/or other parameters (e.g., 5G Protocol Data Unit (PDU) session service requirements/characteristics). These parameters may be seamlessly mapped over effective transport slices to achieve a desired/target bandwidth, latency, Service Level Agreement (SLA) guarantee, and other criteria offered in backhaul, mid-haul and front-haul connectivity segments between RAN 140 and UPF 175.

In one specific example, a Service Provider (SP) (e.g., a Communication Service Provider (CSP)) manages system 100 on behalf of a factory owner, and wireless device 135 is an IoT device in the factory. Provisioning interface 105 may obtain a service order from the factory owner, and provide, to network orchestrator 110, a request associated with the service order. In this example, the service order may indicate end-to-end handling behavior of network packets to/from wireless device 135 desired by the factory owner. Thus, the service request may specify a specific service and specify any requirements (e.g., packet handling requirements) for that service.

Based on the request, network orchestrator 110 may effectively provision an end-to-end network slice across RAN 140, transport domain 145, and core network 150. In particular, network orchestrator 110 may provide, to RAN controller 115 and core network controller 125, a mapping between (1) an indicator that indicates how to handle network packets associated with wireless device 135 in transport domain 145, and (2) a behavior identifier that corresponds to a target behavior of the network packets associated with wireless device 135 in transport domain 145. In one example, the indicator may indicate how to handle network packets associated with wireless device 135 in transport domain 145 for a requested Data Network Name (DNN).

The indicator may also be referred to herein as a “color code.” In one example, the color code may include binary bits and may correspond to an IP transport segment/path/slice of transport domain 145. The behavior identifier may indicate a service level (e.g., high reliability, low latency, high bandwidth, etc.) to be achieved in transport domain 145 as indicated by wireless device 135. The color code and the behavior identifier may be extensible, flexible, SP-controlled values.

The color code and/or behavior identifier may be configured manually, semi-automatically, or fully automatically. In one example, the color code and/or behavior identifier may be configured manually or semi-automatically by the SP. For instance, the SP may specify the color code and/or behavior identifier based on the service order. In another example, the color code and/or behavior identifier may be configured fully automatically (e.g., by provisioning interface 105 and/or network orchestrator 110) based on the target behavior of the network packets associated with wireless device 135 in transport domain 145 as indicated by the factory owner in the service order.

Network orchestrator 110 may also provide RAN slice information to RAN controller 115, and core network slice information to core network controller 125. RAN controller 115 may provide the RAN slice information, the color code, and the behavior identifier to NFVO 130. NFVO 130 may, in turn, provide the RAN slice information, the color code, and the behavior identifier to RAN 140. In one example, NFVO 130 may provide the color code and behavior identifier to CU 165. NFVO 130 may also alter the mapping before pushing the mapping to RAN 140. Core network controller 125 may provide the core network slice information, the color code, and the behavior identifier to core network 150 (e.g., UPF 175). In one example, core network controller 125 may provide the core network slice information to core network 150 via an NFVO, which may be configured to alter the mapping before pushing the mapping to core network 150.

In one example, RAN 140 and core network 150 may each maintain a mapping between (1) a plurality of color codes that indicate how to handle network packets in transport domain 145, and (2) a plurality of behavior identifiers that correspond to respective target behaviors of the network packets in transport domain 145. RAN 140 and core network 150 may obtain the plurality of color codes and the plurality of behavior identifiers concurrently (e.g., in response to the service order), or may build-up the mapping between the color codes and behavior identifiers over time (e.g., in response to multiple service orders from a single entity or multiple entities). The plurality of color codes and behavior identifiers may correspond to wireless device 135 and/or one or more other wireless devices. In a further example, transport domain 145 may obtain the plurality of color codes maintained by RAN 140 and core network 150.

In one example, CU 165 and UPF 175 obtain one or more parameters associated with wireless device 135. The one or more parameters may be obtained from a session associated with wireless device 135 (e.g., in response to core network 150 obtaining a session request from wireless device 135). In one example, the one or more parameters may include Single—Network Slice Selection Assistance Information (S-NSSAI), such as Slice/Service Type (SST) and/or Slice Differentiator (SD), associated with wireless device 135; a target quality of service associated with wireless device 135; subscription information associated with wireless device 135 (e.g., an SLA) between the SP and the factory owner); or any other suitable parameter depending on the specific use case.

Based on the one or more parameters, CU 165 and UPF 175 may identify the color code that indicates how to handle uplink packets associated with wireless device 135 in transport domain 145. For example, CU 165 and UPF 175 may identify, from among the plurality of behavior identifiers, the behavior identifier that corresponds to a target behavior of the uplink packets associated with wireless device 135 in transport domain 145. CU 165 and UPF 175 may identify the behavior identifier using information obtained from RAN controller 115 and core network controller 125, based on control plane knowledge of target service levels for the uplink packet. In response to identifying the behavior identifier, CU 165 and UPF 175 may identify the color code from among the plurality of color codes based on the mapping. CU 165 and UPF 175 may identify the same or different color codes, depending on the specific use case.

In one example, CU 165 and/or UPF 175 may share an indication of the derived color code with network orchestrator 110 (e.g., via NFVO 130 and RAN controller 115). Network orchestrator 110 may provide, to transport controller 120, the color code and an indication of the target behavior of the network packets associated with wireless device 130 in transport domain 145 as indicated by the factory owner in the service order. In one example, network orchestrator 110 may provide a pre-defined mapping between the color code and one or more transport domain paths/policies, thereby provisioning the effective transport domain network slices to transport controller 120. It will be appreciated that, in other examples, network orchestrator 110 may provide the indication of the color code to transport controller 120 before, or without, obtaining the indication of the derived color code from CU 165 and/or UPF 175.

Transport controller 120 may, in turn, provide the color code and the indication of the target behavior of the network packets to transport domain 145 (e.g., to router 170(1) and router 170(2)). For example, router 170(1) and router 170(2) may modify their respective routing tables based on the information provided by transport controller 120. Transport controller 120 may provision a network path in transport domain 145 that corresponds to the color code obtained from network orchestrator 110. Transport controller 120 may communicate with transport domain 145 via Path Computation Element Communication Protocol (PCEP).

CU 165 may obtain an uplink packet from wireless device 135. In one example, the uplink packet belongs to the session from which the one or more parameters were obtained. Having identified the color code, CU 165 may insert the color code into the uplink packet. For example, CU 165 may insert the color code into a header of the uplink packet, which may be a GTP-U packet. In one example, CU 165 may generate a Tunnel Endpoint Identifier (TE-ID) having a value within a given range mapped to the behavior identifier. A TE-ID may be located in the header of a GTP-U packet inside a User Datagram Protocol (UDP) payload. CU 165 may generate multiple TE-IDs (and/or multiple TE-ID ranges) corresponding to multiple respective behavior identifiers.

In another example, CU 165 may insert the color code in an extension header of the uplink packet. In one example, the extension header may be a first (e.g., initial) extension header of the uplink packet; that is, the extension header may be the first extension header of all GTP-U extension headers that belong to the uplink packet. In one specific example, the first extension header may be a PDU session container extension header.

Regardless of the specific encapsulation method for carrying the transport slice information (e.g., inserting the color code as a TE-ID and/or in an extension header), after inserting the color code into the uplink packet, CU 165 may provide the uplink packet to transport domain 145 (e.g., to router 170(1)) via CU 165. In one example, RAN 140 may handle the uplink packet internally according to a RAN network slice. The uplink packet may carry the color code to transport domain 145, thereby indicating effective transport slices on the data path of the uplink packet.

In other examples, one or more of the operations carried out by CU 165 may be performed by any other suitable network entities belonging to RAN 140. For example, the other network entity/entities may identify the behavior identifier, identify the color code, and/or insert the color code into the uplink packet.

Transport domain 145 may be configured to handle the uplink packet in transport domain 145 based on the color code. In one example, router 170(1) may obtain the uplink packet, look-up the UDP port number to determine that the uplink packet is a GTP-U packet, and, in response, determine the color code of the uplink packet.

If CU 165 inserted the color code as a TE-ID, router 170(1) may obtain the TE-ID from the uplink packet, determine that the TE-ID matches a specific range mapped to a given use case/slice. For example, a TE-ID in the range of X-Y may map to a low latency slice, whereas a TE-ID in the range of P-Q may map to a different use-case slice.

Or, if CU 165 inserted the color code in an extension header of the uplink packet, router 170(1) may extract the color code from the extension header. If CU 165 inserted the color code in a first extension header of the uplink packet, such as a PDU session container extension header, router 170(1) may avoid skimming through any other extension headers of the uplink packet and thereby look-up the color code with minimal latency.

Upon identifying the color code, router 170(1) may apply the appropriate policy to the uplink packet (e.g., based on information stored in a routing table in router 170(1)). Router 170(1) may handle (e.g., route) the uplink packet in transport domain 145 based on the color code, slice provisioning, and other information obtained from transport controller 120 and further based on the color code carried in the uplink packet. In one example, router 170(1) may route/forward the uplink packet according to a policy path previously pushed to/programmed on router 170(1) by transport controller 120. Thus, router 170(1) may derive the effective network slice in transport domain 145 based on a mapping of the extracted color code to the relevant network path. Accordingly, the behavior identifier and color code may enable transport domain 145 to identify the relevant transport slice information for the uplink packet and provide seamless end-to-end slicing capabilities based on the intended behavior of wireless device 135.

The uplink packet may proceed across transport domain 145 according to the network path corresponding to the color code. The uplink packet may reach router 170(2), which may in turn forward the uplink packet to core network 150 (e.g., UPF 175). Core network 150 may obtain the uplink packet, handle the uplink packet internally according to a core network slice, and provide the uplink packet to application server 155.

In response to the uplink packet, application 180 may cause application server 155 to generate a downlink packet and provide the downlink packet to core network 150. In one example, UPF 175 obtains the downlink packet from application server 155. Having previously identified a color code for the downlink packet, UPF 175 may insert the color code into the downlink packet. For example, UPF 175 may insert the color code as a TE-ID or in an extension header of the downlink packet. In one example, UPF 175 may encapsulate the color code in the downlink packet using the same mechanism that CU 165 used to encapsulate the color code in the uplink packet. After inserting the color code into the downlink packet, UPF 175 may provide the downlink packet to transport domain 145 (e.g., to router 170(2)). In one example, core network 150 may handle the downlink packet internally according to a core network slice. The downlink packet may carry the color code to transport domain 145, thereby indicating effective transport slices on the data path of the downlink packet.

Transport domain 145 may be configured to handle the downlink packet in transport domain 145 based on the color code. In one example, router 170(2) may obtain the downlink packet, look-up the UDP port number to determine that the downlink packet is GTP-U packet, and, in response, determine the color code of the downlink packet.

Upon identifying the color code, router 170(2) may apply the appropriate policy to the downlink packet (e.g., based on information stored in a routing table in router 170(2)). Router 170(2) may handle (e.g., route) the downlink packet in transport domain 145 based on the color code, slice provisioning, and other information obtained from transport controller 120 and further based on the color code carried in the downlink packet. In one example, router 170(2) may route/forward the downlink packet according to a policy path previously pushed to/programmed on router 170(2) by transport controller 120. Thus, router 170(2) may derive the effective network slice in transport domain 145 based on a mapping of the extracted color code to the relevant network path. Accordingly, the behavior identifier and color code may enable transport domain 145 to identify the relevant transport slice information for the downlink packet and provide seamless end-to-end slicing capabilities based on the intended behavior of wireless device 135.

The downlink packet may proceed across transport domain 145 according to the network path corresponding to the color code. The downlink packet may reach router 170(1), which may in turn forward the downlink packet to RAN 140. RAN 140 may obtain the downlink packet, handle the downlink packet internally according to a RAN slice (e.g., including providing the downlink packet from CU 165 to DU 160), and provide the downlink packet to wireless device 135.

Thus, network packets (e.g., uplink and downlink packets) may be handled in a consistent, end-to-end manner across RAN 140, transport domain 145, and core network 150. The target behavior of the network packet(s) on transport domain 145 may be enforced using a mapping of a behavior identifier to a color code. To determine the appropriate behavior for a given network packet, the behavior identifier and color code may be identified based on the slice identifier (e.g., SST/SD), QoS parameters, subscription information, and/or any other suitable parameters that may help realize the target behavior of the network packet in transport domain 145.

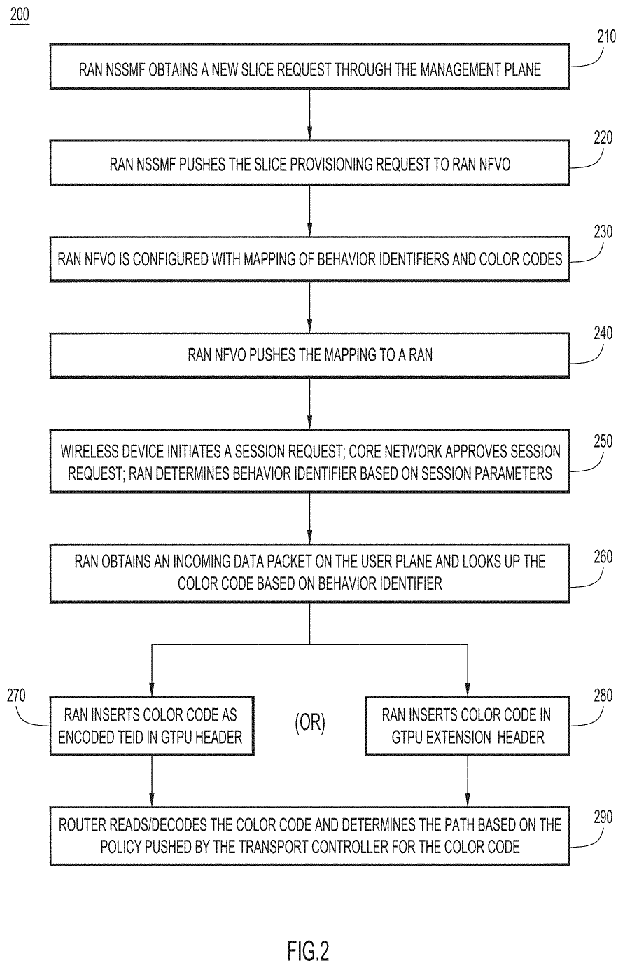

With continuing reference to FIG. 1, FIG. 2 illustrates a flowchart of a method 200 for handling network packets in a transport domain, according to an example embodiment. Method 200 applies to uplink packets, though it will be appreciated that similar operations may apply to downlink packets.

At operation 210, a RAN NSSMF (e.g., RAN controller 115) obtains a new slice provisioning request through the management plane. The management plane may include a slice provisioning interface, such as provisioning interface 105 (e.g., a CSMF), and a network orchestrator, such as network orchestrator 110 (e.g., an NSMF). The slice provisioning interface may interface with an Operations Support System and/or Business Support System (OSS/BSS) to receive the service order and translate the service order requirements into slice requirements for the management plane, e.g., the NSMF.

At operation 220, the RAN NSSMF pushes the slice provisioning request to a RAN NFVO (e.g., NFVO 130). At operation 230, the RAN NFVO is configured with the mapping of behavior identifiers (which may be determined based on slice ID and QoS) and color codes. At operation 240, the RAN NFVO pushes the mapping to a RAN (e.g., RAN 140, including a gNodeB). In one example, the RAN NFVO may push the mapping to a database in a CU (e.g., CU 165). This may enable the RAN to apply the mapping to incoming requests.

At operation 250, a wireless device (e.g., wireless device 135) initiates/sends a session request toward a core network (e.g., core network 150). The core network may approve the session request and establish a session with the wireless device. The RAN may determine the behavior ID based on one or more parameters associated with the session (e.g., slice identifier, QoS, etc.). For example, the RAN may identify the behavior identifier by looking into the database in the DU.

At operation 260, the RAN obtains an uplink packet (e.g., an incoming data packet) on the user plane and, based on the behavior identifier, looks up/identifies the color code mapped to the behavior identifier in the database in the DU. The uplink packet may be the first data packet obtained by the RAN from the wireless device. The RAN may associate the color code with the wireless device/session; this may enable the RAN to add the same color code to any further incoming packets from the wireless device.

Operations 270 and 280 may be alternative options for the RAN to insert the color code in the uplink packet. In the specific example of operations 270 and 280, the uplink packet may be a GTP-U packet. At operation 270, the RAN inserts the color code as an encoded TE-ID in a GTP-U header. At operation 280, the RAN inserts the color code in a GTP-U extension header.

At operation 290, an ingress router of the transport domain (e.g., router 170(1)) reads/decodes the color code and determines the path for the uplink packet based on the color code policy pushed by the transport controller of the transport domain. The transport domain may then route the uplink packet over the determined path.

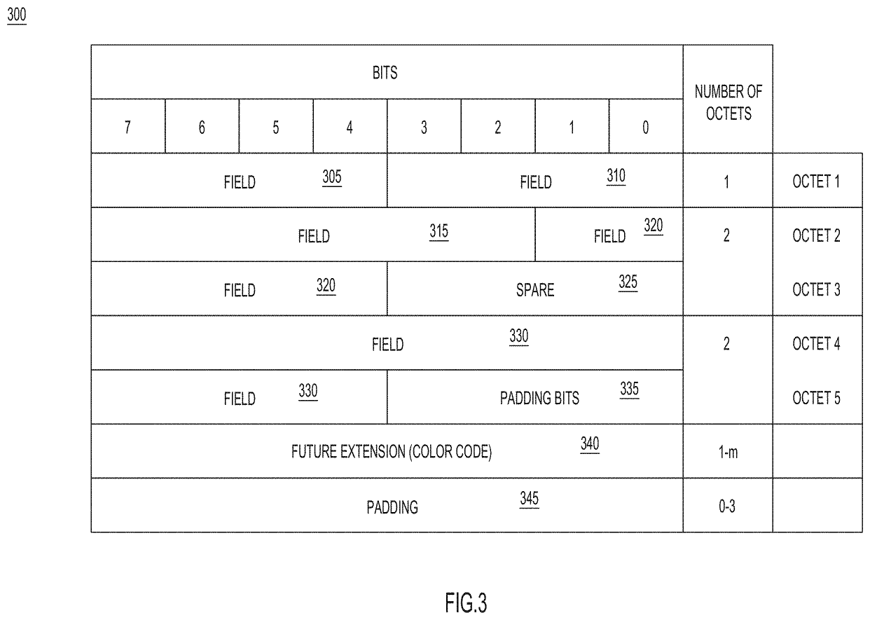

FIG. 3 illustrates GTP-U extension header 300, according to an example embodiment. GTP-U extension header 300 includes fields 305-320, spare field 325, field 330, padding bits field 335, future extension field 340, and padding field 345. Field 305 is located in octet 1 at bits 4-7; field 310 is located in octet 1 at bits 0-3; field 315 is located in octet 2 at bits 2-7; field 320 is located in octet 2 at bits 0 and 1 and in octet 3 at bits 4-7; spare field 325 is located in octet 3 at bits 0-3; field 330 is located in octet 4 at bits 0-7 and in octet 5 at bits 4-7; padding bits field 335 is located in octet 5 at bits 0-3; future extension field 340 is located in one or more octets at bits 0-7; and padding field 345 is located in zero to three octets at bits 0-7. In one example, GTP-U extension header 300 may be an uplink PDU session container extension header.

GTP-U extension header 300 may belong to an uplink packet destined for an application server. GTP-U extension header 300 may carry a color code, inserted by a RAN en route to the application server, which indicates how a transport domain should handle the uplink packet. More specifically, the RAN may insert the color code as bits in future extension field 340 and send the uplink packet to the transport domain/layer, which looks into GTP-U extension header 300, reads the color code from future extension field 340, and treats the uplink packet accordingly as per the policy pushed via a transport controller of the transport domain. The transport domain may provide the uplink packet to a core network, and a UPF of the core network may thereby obtain the uplink PDU session container information from the RAN.

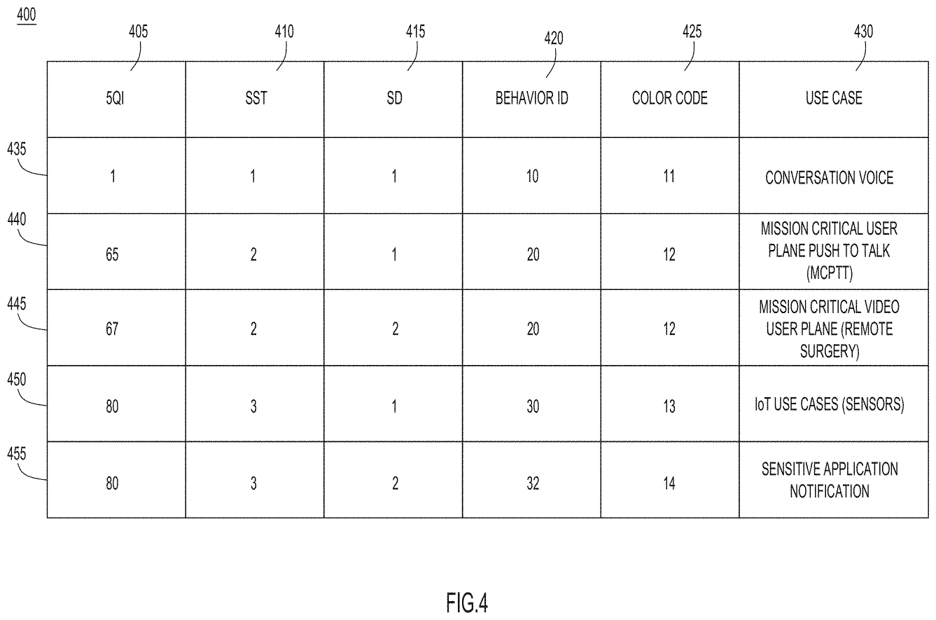

FIG. 4 illustrates a table 400 that maps parameters associated with a wireless device (e.g., 5QI, SST, and SD) with behavior identifiers, color codes, and corresponding use cases, according to an example embodiment. Table 400 includes columns 405-430 and rows 435-455. Column 405 includes a plurality of 5QIs; column 410 includes a plurality of SSTs; column 415 includes a plurality of SDs; column 420 includes a plurality of behavior identifiers; column 425 includes a plurality of color codes; and column 430 includes a plurality of use cases. Rows 435-455 associate the 5QIs, SSTs, SDs, behavior identifiers, color codes, and use cases.

For example, row 435 associates a 5QI of value 1, an SST of value 1, an SD of value 1, a behavior identifier of value 10, a color code of value 11, and a voice conversation use case. This means, for instance, that a RAN or UPF may identify a behavior identifier of value 10 and a color code of value 11 for a network packet associated with a 5QI of value 1, an SST of value 1, an SD of value 1. The RAN or UPF may further insert the color code of value 11 in the network packet, which may be used for voice conversation use cases.

Row 440 associates a 5QI of value 65, an SST of value 2, an SD of value 1, a behavior identifier of value 20, a color code of value 12, and a Mission-Critical Push-to-Talk (MCPTT) use case. This means, for instance, that a RAN or UPF may identify a behavior identifier of value 20 and a color code of value 12 for a network packet associated with a 5QI of value 65, an SST of value 2, an SD of value 1. The RAN or UPF may further insert the color code of value 12 in the network packet, which may be used for MCPTT use cases.

Row 445 associates a 5QI of value 67, an SST of value 2, an SD of value 2, a behavior identifier of value 20, a color code of value 12, and a mission-critical video user plane use case, such as remote surgery. This means, for instance, that a RAN or UPF may identify a behavior identifier of value 20 and a color code of value 12 for a network packet associated with a 5QI of value 67, an SST of value 2, an SD of value 2. The RAN or UPF may further insert the color code of value 12 in the network packet, which may be used for MCPTT use cases.

Row 450 associates a 5QI of value 80, an SST of value 3, an SD of value 1, a behavior identifier of value 30, a color code of value 13, and an IoT use case, such as sensor applications. This means, for instance, that a RAN or UPF may identify a behavior identifier of value 30 and a color code of value 13 for a network packet associated with a 5QI of value 80, an SST of value 3, an SD of value 1. The RAN or UPF may further insert the color code of value 13 in the network packet, which may be used for IoT use cases.

Row 455 associates a 5QI of value 80, an SST of value 3, an SD of value 2, a behavior identifier of value 32 a color code of value 14, and sensitive application notification use case. This means, for instance, that a RAN or UPF may identify a behavior identifier of value 32 and a color code of value 14 for a network packet associated with a 5QI of value 80, an SST of value 3, an SD of value 2. The RAN or UPF may further insert the color code of value 14 in the network packet, which may be used for sensitive application notification use cases.

As shown in rows 440 and 445, different parameter values (e.g., 5QI values of 65 and 67) may be mapped to the same behavior identifier value (e.g., 20). Therefore, PDU sessions having similar requirements (e.g., mission-critical use cases) may be mapped to the same color code (e.g., 12) and hence the same transport path. As a result, techniques described herein may allow for N:1 mapping in a specific slice class from the RAN or core network to the transport network.

Conversely, as shown in rows 450 and 455, the same parameter values (e.g., 5QI value of 80 and SST value of 3) may be mapped to different behavior identifiers (e.g., 30 and 32). Therefore, PDU sessions having different requirements (e.g., IoT use cases versus sensitive application notification use cases) may be mapped to different color codes (e.g., 13 and 14) and hence different transport paths.

A SP may flexibly and dynamically employ any suitable mappings with any suitable numbers of behavior identifiers and color codes. The exact mappings and numbers may depend on the specific use cases that the SP is servicing at any given time. Depending on the SP, the color codes/transport slices in the routing domain may be limited in number, or a large combination may be generated for the large number of use cases that may arise in the 5G domain for SPs to handle.

The SP may differentiate service performance based on specific use cases using the color code. In one example, the SP may provide a color code for the behavior identifiers of the respective use cases. Thus, the SP may influence routing decisions and potentially routing computations in the transport domain. In particular, the mobility control plane may influence the routing within a transport slice handling a given use case by providing an indication of 5QI and slice identifier (for example) in the form of color code to the transport domain.

The color code may be inserted into a network packet to reflect/indicate a selected path in the transport domain. The color code may be mapped to a certain range of values in the TE-ID of the network packet (e.g., a GTP-U packet), or inserted in an extension header of the network packet, and carried to the transport domain. When it obtains the network packet, the transport domain may extract the color code and determine the appropriate network path based on the color code and information obtained from the transport controller.

The color code (which may be determined by the SP) may be based on the behavior identifier, which may in turn be based on 5QI, S-NSSAI, and/or other parameters such as subscription level (e.g., standard versus premium support). For example, if a factory owner has a premium subscription level to a service within a class, the SP may adjust the SD value and hence the color code. Once the wireless device has obtained authorization for access in the RAN domain, the color code may be added to a GTP-U header of a network packet and seamlessly carried forward to the transport domain, which may determine the transport slice based on the color code and the policy pushed by a transport controller of the transport domain. Thus, techniques described herein may allow automated provisioning of network slices in the transport domain based on slicing characteristics from the RAN and core network domains, as well as other parameters.

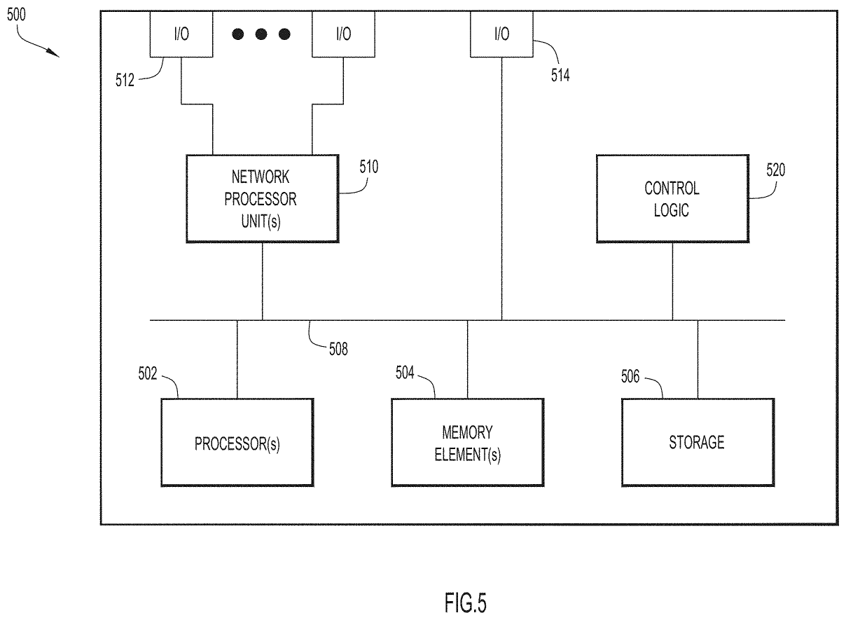

Referring to FIG. 5, FIG. 5 illustrates a hardware block diagram of a computing device 500 that may perform functions associated with operations discussed herein in connection with the techniques depicted in FIGS. 1-4. In various embodiments, a computing device, such as computing device 500 or any combination of computing devices 500, may be configured as any entity/entities as discussed for the techniques depicted in connection with FIGS. 1-4 in order to perform operations of the various techniques discussed herein.

In at least one embodiment, computing device 500 may include one or more processor(s) 502, one or more memory element(s) 504, storage 506, a bus 508, one or more network processor unit(s) 510 interconnected with one or more network input/output (I/O) interface(s) 512, one or more I/O interface(s) 514, and control logic 520. In various embodiments, instructions associated with logic for computing device 500 can overlap in any manner and are not limited to the specific allocation of instructions and/or operations described herein.

In at least one embodiment, processor(s) 502 is/are at least one hardware processor configured to execute various tasks, operations and/or functions for computing device 500 as described herein according to software and/or instructions configured for computing device 500. Processor(s) 502 (e.g., a hardware processor) can execute any type of instructions associated with data to achieve the operations detailed herein. In one example, processor(s) 502 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 504 and/or storage 506 is/are configured to store data, information, software, and/or instructions associated with computing device 500, and/or logic configured for memory element(s) 504 and/or storage 506. For example, any logic described herein (e.g., control logic 520) can, in various embodiments, be stored for computing device 500 using any combination of memory element(s) 504 and/or storage 506. Note that in some embodiments, storage 506 can be consolidated with memory elements 504 (or vice versa), or can overlap/exist in any other suitable manner.

In at least one embodiment, bus 508 can be configured as an interface that enables one or more elements of computing device 500 to communicate in order to exchange information and/or data. Bus 508 can be implemented with any architecture designed for passing control, data and/or information between processors, memory elements/storage, peripheral devices, and/or any other hardware and/or software components that may be configured for computing device 500. In at least one embodiment, bus 508 may be implemented as a fast kernel-hosted interconnect, potentially using shared memory between processes (e.g., logic), which can enable efficient communication paths between the processes.

In various embodiments, network processor unit(s) 510 may enable communication between computing device 500 and other systems, entities, etc., via network I/O interface(s) 512 to facilitate operations discussed for various embodiments described herein. In various embodiments, network processor unit(s) 510 can be configured as a combination of hardware and/or software, such as one or more Ethernet driver(s) and/or controller(s) or interface cards, Fibre Channel (e.g., optical) driver(s) and/or controller(s), and/or other similar network interface driver(s) and/or controller(s) now known or hereafter developed to enable communications between computing device 500 and other systems, entities, etc. to facilitate operations for various embodiments described herein. In various embodiments, network I/O interface(s) 512 can be configured as one or more Ethernet port(s), Fibre Channel ports, and/or any other I/O port(s) now known or hereafter developed. Thus, the network processor unit(s) 510 and/or network I/O interfaces 512 may include suitable interfaces for receiving, transmitting, and/or otherwise communicating data and/or information in a network environment.

I/O interface(s) 514 allow for input and output of data and/or information with other entities that may be connected to computing device 500. For example, I/O interface(s) 514 may provide a connection to external devices such as a keyboard, keypad, a touch screen, and/or any other suitable input device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, control logic 520 can include instructions that, when executed, cause processor(s) 502 to perform operations, which can include, but not be limited to, providing overall control operations of computing device 500; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 520) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, entities as described herein may store data/information in any suitable volatile and/or non-volatile memory item (e.g., magnetic hard disk drive, solid state hard drive, semiconductor storage device, Random Access Memory (RAM), Read Only Memory (ROM), Erasable Programmable ROM (EPROM), Application Specific Integrated Circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, Digital Signal Processing (DSP) instructions, software [potentially inclusive of object code and source code], etc.) for execution by one or more processor(s), and/or other similar machine, etc. Generally, memory element(s) 504 and/or storage 506 can store data, software, code, instructions (e.g., processor instructions), logic, parameters, combinations thereof, and/or the like used for operations described herein. This includes memory elements 504 and/or storage 506 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, Compact Disc ROM (CD-ROM), Digital Versatile Disc (DVD), memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to computing device 500 for transfer onto another computer readable storage medium.

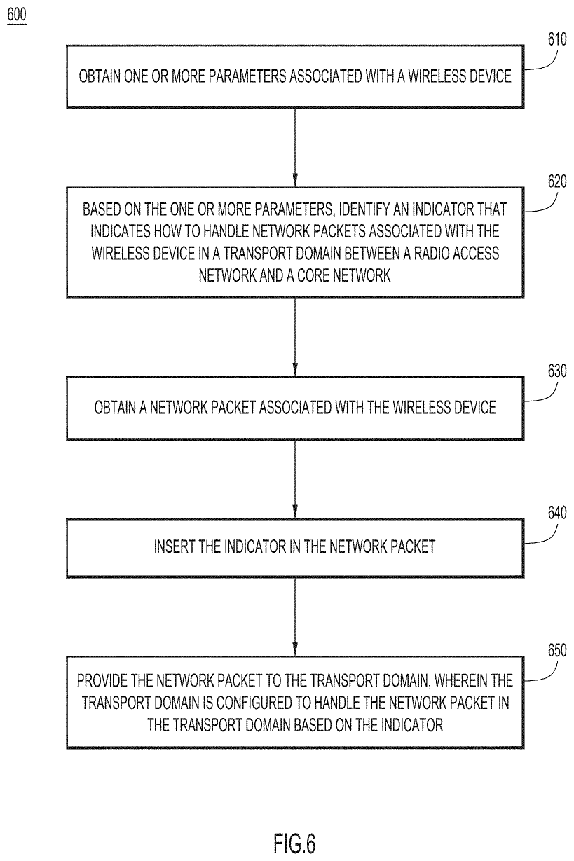

FIG. 6 is a flowchart of an example method 600 for performing functions associated with operations discussed herein. Method 600 may be performed by any suitable entity, such as RAN 140 (e.g., CU 165), core network 150 (e.g., UPF 175), or device 500. At operation 610, one or more parameters associated with a wireless device are obtained. At operation 620, based on the one or more parameters, an indicator (e.g., a color code) is identified that indicates how to handle network packets associated with the wireless device in a transport domain between a radio access network and a core network. At operation 630, a network packet associated with the wireless device is obtained. At operation 640, the indicator is inserted in the network packet. At operation 650, the network packet is provided to the transport domain, where the transport domain is configured to handle the network packet in the transport domain based on the indicator.

[ow] Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any Local Area Network (LAN), Virtual LAN (VLAN), Wide Area Network (WAN) (e.g., the Internet), Software Defined WAN (SD-WAN), Wireless Local Area (WLA) access network, Wireless Wide Area (WWA) access network, Metropolitan Area Network (MAN), Intranet, Extranet, Virtual Private Network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fib®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may be directly or indirectly connected utilizing any algorithms, communication protocols, interfaces, etc. (proprietary and/or non-proprietary) that allow for the exchange of data and/or information.

In various example implementations, entities for various embodiments described herein can encompass network elements (which can include virtualized network elements, functions, etc.) such as, for example, network appliances, forwarders, routers, servers, switches, gateways, bridges, load-balancers, firewalls, processors, modules, radio receivers/transmitters, or any other suitable device, component, element, or object operable to exchange information that facilitates or otherwise helps to facilitate various operations in a network environment as described for various embodiments herein. Note that with the examples provided herein, interaction may be described in terms of one, two, three, or four entities. However, this has been done for purposes of clarity, simplicity and example only. The examples provided should not limit the scope or inhibit the broad teachings of systems, networks, etc. described herein as potentially applied to a myriad of other architectures.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments.

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method.

Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of can be represented using the’(s)′ nomenclature (e.g., one or more element(s)).

In one form, a method is provided. The method comprises: obtaining one or more parameters associated with a wireless device; based on the one or more parameters, identifying an indicator that indicates how to handle network packets associated with the wireless device in a transport domain between a radio access network and a core network; obtaining a network packet associated with the wireless device; inserting the indicator in the network packet; and providing the network packet to the transport domain, wherein the transport domain is configured to handle the network packet in the transport domain based on the indicator.

In one example, identifying the indicator includes: maintaining a mapping between a plurality of indicators that indicate how to handle network packets in the transport domain, and a plurality of behavior identifiers that correspond to respective target behaviors of the network packets in the transport domain; based on the one or more parameters, identifying, from among the plurality of behavior identifiers, a behavior identifier that corresponds to a target behavior of the network packets associated with the wireless device in the transport domain; and in response to identifying the behavior identifier, identifying the indicator from among the plurality of indicators based on the mapping.

In one example, the method further comprises: at a network orchestrator, providing the indicator to a radio access network controller, a transport domain controller, and a core network controller, wherein the radio access network controller, the transport domain controller, and the core network controller are configured to provide the indicator to the radio access network, the transport domain, and the core network, respectively.

In one example, inserting the indicator in the network packet includes: inserting the indicator as a tunnel endpoint identifier of the network packet.

In one example, inserting the indicator in the network packet includes: inserting the indicator in an extension header of the network packet. In a further example, inserting the indicator in the extension header of the network packet includes: inserting the indicator in a first extension header of the network packet.

In one example, the method is performed by the radio access network, and the network packet is an uplink packet. In another example, the method is performed by the core network, and the network packet is a downlink packet.

In one example, obtaining the one or more parameters includes: obtaining one or more of network slice selection assistance information associated with the wireless device. In another example, obtaining the one or more parameters includes: obtaining an indication of a target quality of service associated with the wireless device. In still another example, obtaining the one or more parameters includes: obtaining subscription information associated with the wireless device.

In another form, an apparatus is provided. The apparatus comprises: a network interface configured to obtain or provide network communications; and one or more processors coupled to the network interface, wherein the one or more processors are configured to: obtain one or more parameters associated with a wireless device; based on the one or more parameters, identify an indicator that indicates how to handle network packets associated with the wireless device in a transport domain between a radio access network and a core network; obtain a network packet associated with the wireless device; insert the indicator in the network packet; and provide the network packet to the transport domain, wherein the transport domain is configured to handle the network packet in the transport domain based on the indicator.

In another form, one or more non-transitory computer readable storage media are provided. The non-transitory computer readable storage media are encoded with instructions that, when executed by a processor, cause the processor to: obtain one or more parameters associated with a wireless device; based on the one or more parameters, identify an indicator that indicates how to handle network packets associated with the wireless device in a transport domain between a radio access network and a core network; obtain a network packet associated with the wireless device; insert the indicator in the network packet; and provide the network packet to the transport domain, wherein the transport domain is configured to handle the network packet in the transport domain based on the indicator.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A method comprising:
obtaining one or more parameters associated with a wireless device;
based on the one or more parameters, identifying an indicator that indicates how to handle network packets associated with the wireless device in a transport domain between a radio access network and a core network;
obtaining a network packet associated with the wireless device;
inserting the indicator in the network packet; and
providing the network packet to the transport domain, wherein the transport domain is configured to handle the network packet in the transport domain based on the indicator.

2. The method of claim 1, wherein identifying the indicator includes:
maintaining a mapping between a plurality of indicators that indicate how to handle network packets in the transport domain, and a plurality of behavior identifiers that correspond to respective target behaviors of the network packets in the transport domain;
based on the one or more parameters, identifying, from among the plurality of behavior identifiers, a behavior identifier that corresponds to a target behavior of the network packets associated with the wireless device in the transport domain; and
in response to identifying the behavior identifier, identifying the indicator from among the plurality of indicators based on the mapping.

3. The method of claim 1, further comprising:
at a network orchestrator, providing the indicator to a radio access network controller, a transport domain controller, and a core network controller, wherein the radio access network controller, the transport domain controller, and the core network controller are configured to provide the indicator to the radio access network, the transport domain, and the core network, respectively.

4. The method of claim 1, wherein inserting the indicator in the network packet includes:
inserting the indicator as a tunnel endpoint identifier of the network packet.

5. The method of claim 1, wherein inserting the indicator in the network packet includes:
inserting the indicator in an extension header of the network packet.

6. The method of claim 5, wherein inserting the indicator in the extension header of the network packet includes:
inserting the indicator in a first extension header of the network packet.

7. The method of claim 1, wherein the method is performed by the radio access network, and the network packet is an uplink packet.

8. The method of claim 1, wherein the method is performed by the core network, and the network packet is a downlink packet.

9. The method of claim 1, wherein obtaining the one or more parameters includes:
obtaining one or more of network slice selection assistance information associated with the wireless device.

10. The method of claim 1, wherein obtaining the one or more parameters includes:
obtaining an indication of a target quality of service associated with the wireless device.

11. The method of claim 1, wherein obtaining the one or more parameters includes:
obtaining subscription information associated with the wireless device.

12. An apparatus comprising:
a network interface configured to obtain or provide network communications; and
one or more processors coupled to the network interface, wherein the one or more processors are configured to:
obtain one or more parameters associated with a wireless device;
based on the one or more parameters, identify an indicator that indicates how to handle network packets associated with the wireless device in a transport domain between a radio access network and a core network;
obtain a network packet associated with the wireless device;
insert the indicator in the network packet; and
provide the network packet to the transport domain, wherein the transport domain is configured to handle the network packet in the transport domain based on the indicator.

13. The apparatus of claim 12, wherein the one or more processors are configured to:
maintain a mapping between a plurality of indicators that indicate how to handle network packets in the transport domain, and a plurality of behavior identifiers that correspond to respective target behaviors of the network packets in the transport domain;
based on the one or more parameters, identify, from among the plurality of behavior identifiers, a behavior identifier that corresponds to a target behavior of the network packets associated with the wireless device in the transport domain; and
in response to identifying the behavior identifier, identify the indicator from among the plurality of indicators based on the mapping.

14. The apparatus of claim 12, wherein the one or more processors are configured to:
insert the indicator as a tunnel endpoint identifier of the network packet.

15. The apparatus of claim 12, wherein the one or more processors are configured to:
insert the indicator in an extension header of the network packet.

16. The apparatus of claim 15, wherein the one or more processors are configured to:
insert the indicator in a first extension header of the network packet.

17. One or more non-transitory computer readable storage media encoded with instructions that, when executed by a processor, cause the processor to:
obtain one or more parameters associated with a wireless device;
based on the one or more parameters, identify an indicator that indicates how to handle network packets associated with the wireless device in a transport domain between a radio access network and a core network;
obtain a network packet associated with the wireless device;
insert the indicator in the network packet; and
provide the network packet to the transport domain, wherein the transport domain is configured to handle the network packet in the transport domain based on the indicator.

18. The one or more non-transitory computer readable storage media of claim 17, wherein the instructions cause the processor to:
maintain a mapping between a plurality of indicators that indicate how to handle network packets in the transport domain, and a plurality of behavior identifiers that correspond to respective target behaviors of the network packets in the transport domain;
based on the one or more parameters, identify, from among the plurality of behavior identifiers, a behavior identifier that corresponds to a target behavior of the network packets associated with the wireless device in the transport domain; and
in response to identifying the behavior identifier, identify the indicator from among the plurality of indicators based on the mapping.

19. The one or more non-transitory computer readable storage media of claim 17, wherein the instructions cause the processor to:
insert the indicator as a tunnel endpoint identifier of the network packet.

20. The one or more non-transitory computer readable storage media of claim 17, wherein the instructions cause the processor to:
insert the indicator in an extension header of the network packet.
